(19) United States
(12) Patent Application Publication
(10) Pub. No.: US 2017/0266953 A1
(43) Pub. Date: Sep. 21, 2017

(54) RECORDING APPARATUS AND RECORDING METHOD

(71) Applicant: SEIKO EPSON CORPORATION, Tokyo (JP)

(72) Inventors: Kazuyoshi TANASE, Matsumoto (JP); Yuichi WASHIO, Matsumoto (JP); Satoru KATAGAMI, Matsumoto (JP); Tsutomu SASAKI, Matsumoto (JP)

(21) Appl. No.: 15/450,313

(22) Filed: Mar. 6, 2017

(30) Foreign Application Priority Data
Mar. 17, 2016 (JP) 2016-053332

(51) Int. Cl. B41J 2/045

(52) U.S. Cl. CPC B41J 2/04505

(57) ABSTRACT

In a recording apparatus that forms dots based on an interlace system, a movement amount when a recording unit is moved in a first direction, between one relative movement of the recording unit to a recording medium in a second direction and the next relative movement, is set to a regular amount Δy=HL (HL is the length of a recording head in the first direction)−OL (OL is the width of an overlap amount in the first direction)±PL (PL is the width of one pixel of printing resolution of a print image to be recorded by the recording unit in the first direction).

### BACKGROUND

1. Technical Field

The present invention relates to a recording apparatus.

2. Related Art

A recording apparatus (a so-called ink jet printer) that performs printing by ejecting inks (droplets) onto a recording medium and forming dots is known. Such a recording apparatus is provided with a recording unit that is capable of relatively moving with respect to a printing medium in each of a main scanning direction and a sub-scanning direction and a recording head attached to the recording unit. A plurality of nozzles are included in the recording head, and the recording apparatus ejects the inks from each of the nozzles. A configuration for such a recording apparatus, in which a plurality of recording heads are disposed in zigzags on the recording unit, is described in JP-A-2012-152957.

An “interlace system” is known as a method for forming dots in the aforementioned recording apparatus. Under the interlace system, a clearance of each raster line formed on the recording medium is buried by the first pass and thus raster lines are formed by the second and subsequent passes.

FIG. 1 illustrates an example of a recording unit U in which a plurality of recording heads Hd are disposed in zigzags. FIG. 1 illustrates a configuration of a bottom surface side (a direction in which the recording unit is seen from the recording medium) of the recording unit U. In FIG. 1, a reference sign X is attached to an arrow indicating a main scanning direction of the recording unit U, and a reference sign Y is attached to an arrow indicating a sub-scanning direction. A direction orthogonal to the main scanning direction X and the sub-scanning direction Y is referred to as a depth direction Z. In addition, in the recording unit U, an aggregation of the recording heads Hd (FIG. 1: dot-hatched) disposed on the right is referred to as a “right head”, and an aggregation of the recording heads Hd (FIG. 1: obliquely hatched) disposed on the left is referred to as a “left head” among the plurality of recording heads Hd disposed in zigzags. In FIG. 1, the right head is marked by enclosing with a one-dot chain line and the left head is marked by enclosing with a dashed line.

FIG. 2 is a view illustrating a problem of the related art. In FIG. 2, each of dots on the recording medium formed by the nozzles of the right head is represented by a circle with a thin outline and dots formed on the recording medium by the nozzles of the left head is represented by a circle with a thick outline. In a case where the recording unit U, in which the plurality of recording heads Hd illustrated in FIG. 1 are disposed in zigzags, performs printing under the interlace system,
a first region in which only raster lines (FIG. 2: L1 to L4) formed by the nozzles of the right head are included, and
a second region in which both of raster lines (FIGS. 2: L5 and L7) formed by the nozzles of the right head and raster lines (FIGS. 2: L6 and L8) formed by the nozzles of the left head are included exist on the recording medium at the same time.

Meanwhile, as illustrated in FIG. 1, in some cases, the recording unit U tilts about a rotation axis parallel to the depth direction Z with respect to the sub-scanning direction Y, for example, due to various factors including a manufacturing error and a situation of use (that is, the nozzle rows of the recording heads Hd come into a state of not being in parallel with the sub-scanning direction Y). In this way, in a case where the recording unit U is tilted with respect to the sub-scanning direction Y, the position of the right head on the recording unit U is uniformly shifted to an upper side or to a lower side in the sub-scanning direction Y with respect to the position of the left head, compared to the position in a case where the recording unit U is in parallel with the sub-scanning direction Y.

In a case where the recording unit U in a state where the positions of the right and the left heads are shifted performs printing under the aforementioned interlace system, intervals IN4 to IN6 between the raster lines formed by the nozzles of the right head and the raster lines formed by the nozzles of the left head become uneven. For example, in an example of FIG. 2, the intervals IN4 and IN6 of the raster lines formed by the nozzles of the right and the left heads are smaller compared to intervals IN1 to IN3 between the raster lines formed by the nozzles of the same right head. Similarly, the interval IN5 of the raster lines formed by the nozzles of the right and the left heads is larger compared to the intervals IN1 to IN3 between the raster lines formed by the nozzles of the same right head. Therefore, the second region having the large interval IN5 appears thinner compared to the first region. In this way, the fact that the first region and the second region exist at the same time on the printing medium is not preferable since the coexistence causes banding unevenness (strip-like density unevenness) on the printing medium.

Such a problem applies the same to a case where the first region includes only the raster lines formed by the nozzles of the left head. In addition, such a problem applies the same to a case where two or more (for example, three) recording heads are disposed so as to be arranged in the main scanning direction of the recording unit.

For this reason, it is desirable for the recording apparatus that performs printing under the interlace system using the recording unit, in which the plurality of recording heads are disposed in zigzags, to restrict the occurrence of banding unevenness.

### SUMMARY

The invention can be realized in the following aspect.

(1) According to an aspect of the invention, a recording apparatus is provided. The recording apparatus includes: a recording unit that has a plurality of nozzles disposed at a regular nozzle interval in a first direction and has a plurality of recording heads which discharge a liquid from the nozzles and form dots onto a recording medium; a carriage that moves the recording unit with respect to each of the first direction and a second direction orthogonal to the first direction; and a control unit that controls a movement of the recording unit and a formation of the dots performed by each of the nozzles based on an interlace system. In the recording unit, n (n is a natural number that is equal to or greater than 2) recording heads as the plurality of recording heads are disposed in the second direction; m (m is a natural number that is equal to or greater than 1) sets of the n recording heads are disposed in the first direction; and the n recording heads are disposed such that positions thereof in the first direction are shifted away from each other in a manner that an area occupied by the nozzles disposed within any one of the recording heads in the first direction and an area occupied by the nozzles disposed within the other one of the recording heads in the first direction overlap each other by a predetermined overlap amount. The control unit sets a movement amount when the recording unit is moved in the first direction, between one relative movement of the recording unit to the recording medium in the second direction and the next relative movement, to a regular amount Δy=HL (HL is the length of the recording head in the first direction)−OL (OL is the width of the overlap amount in the first direction)±PL (PL is the width of one pixel of printing resolution of a print image to be recorded by the recording unit in the first direction). According to the recording apparatus of this aspect, between one main scanning and the next main scanning, the control unit sets a movement amount Δy when moving the recording unit in the first direction to an amount obtained based on HL (HL is the length of the recording head in the first direction)−OL (OL is the width of the overlap amount in the first direction)±PL (PL is the width of one pixel of printing resolution of the print image to be recorded by the recording unit in the first direction). For this reason, in a case where, for example, in the recording heads adjacent to each other, parts of areas occupied by the nozzles within each of the recording heads in the first direction overlap each other, if the nozzle disposed on the upper right within each recording head is observed, the position of the upper right nozzle of the nth recording head that performs one main scanning and the position of the upper right nozzle of the n-1th recording head that performs the next main scanning have become positions shifted away from each other by the width (for example, the nozzle pitch of 0.5) of one pixel of printing resolution of the print image recorded by the recording unit in the first direction. That applies the same to the n-2th recording head in a case of the main scanning after next. As a result, in a case where the raster lines formed on the recording medium are observed, the raster lines formed in one main scanning and the raster lines (that is, the raster lines adjacent to each other formed by the printing of the interlace system) formed in the next main scanning are formed by n recording heads disposed so as to be arranged in the recording unit in the second direction. Therefore, according to the recording apparatus of the aspect, the occurrence of banding unevenness can be restricted in the recording apparatus that prints under the interlace system using the recording unit in which the plurality of recording heads are disposed in zigzags.

(2) In the recording apparatus of the above aspect, the control unit may use, as the length HL of the recording head, the product of the number of the nozzles in the first direction and the nozzle interval in one nozzle row included in one of the recording heads and use the product of an overlap amount E and the nozzle interval as the width OL of the overlap amount.

According to the recording apparatus of this aspect, the control by the control unit can be simplified since the length HL of the recording head and the width OL of the overlap amount can be considered as a reference for the number of the nozzles in an equation for obtaining the movement amount Δy.

(3) In the recording apparatus of the above aspect, the control unit may control the movement amount based on the relationship in a case where there is a switching request from a user and control the movement amount not based on the relationship in a case where there is no switching request from the user. According to the recording apparatus of this aspect, convenience for user can be improved since the control unit can change the movement amount when moving the recording unit in the first direction between one main scanning and the next main scanning by taking the switching request from the user as an opportunity.

(4) In the recording apparatus of the above aspect, a tilt detection unit that detects tilting of the recording unit is further included. The control unit may control the movement amount based on the relationship in a case where the tilt detection unit has detected that the recording unit is not in parallel with the first direction, and control the movement amount not based on the relationship in a case where the tilt detection unit has not detected that the recording unit is not in parallel with the first direction. According to the recording apparatus of this aspect, convenience for user can be improved and print image quality can be improved since the control unit can change the movement amount when moving the recording unit in the first direction between one main scanning and the next main scanning by taking the occurrence of tilting of the recording unit as an opportunity.

Not all of a plurality of configuration elements having each aspect of the aforementioned invention are required to be incorporated. To solve a part of or the whole of the aforementioned problems or to achieve a part of or the whole of the aforementioned effects described in this specification, a part of content that limits the scope of the invention can be deleted by some configuration elements out of the plurality of configuration elements being appropriately changed, deleted, and substituted by a new configuration element. In addition, to solve a part of or the whole of the aforementioned problems or to achieve a part of or the whole of the aforementioned effects described in this specification, a part of or the whole of technical characteristics included in the aforementioned aspect of the invention can be made into an independent aspect of the invention by being combined with a part of or the whole of technical characteristics included in other aspect of the aforementioned invention.

The invention can be realized in various forms. For example, the invention can be realized in forms such as a recording apparatus, a control method for the recording apparatus, a system including the recording apparatus, a computer program for realizing the method, the apparatus, the function of the system, an apparatus for distributing the computer program, and a storage medium that stores the computer program.

### BRIEF DESCRIPTION OF THE DRAWINGS

The invention will be described with reference to the accompanying drawings, wherein like numbers reference like elements.

FIG. 1 illustrates an example of a recording unit in which a plurality of recording heads are disposed in zigzags.

FIG. 2 is a view illustrating a problem of the related art.

FIG. 3 is a view illustrating a schematic configuration of a printing system provided with a recording apparatus according to an embodiment of the invention.

FIG. 4 is a view illustrating a configuration of the recording unit.

FIG. 5 is a view illustrating a condition a3.

FIG. 6 is a view illustrating a phase in which the recording unit of this embodiment forms dots onto a sheet.

FIG. 7 is a view illustrating the phase in which the recording unit of this embodiment forms the dots onto the sheet.

FIG. 8 is a view illustrating the phase in which the recording unit of this embodiment forms the dots onto the sheet.

FIG. 9 is a view illustrating the phase in which the recording unit of this embodiment forms the dots onto the sheet.

FIG. 10 is a view illustrating a phase in which a recording unit of the related art forms dots onto a sheet.

FIG. 11 is a view illustrating the phase in which the recording unit of the related art forms the dots onto the sheet.

FIG. 12 is a view illustrating the phase in which the recording unit of the related art forms the dots onto the sheet.

FIG. 13 is a view illustrating the phase in which the recording unit of the related art forms the dots onto the sheet.

FIG. 14 is a view illustrating a configuration of a recording unit in Variation 1.

FIG. 15 is a view illustrating a configuration of a recording unit in Variation 2.

FIG. 16 is a view illustrating a configuration of a recording unit in Variation 3.

FIG. 17 is a view illustrating a schematic configuration of a printing system in a second embodiment.

### DESCRIPTION OF EXEMPLARY EMBODIMENTS

### First Embodiment

### Configuration of Printing System

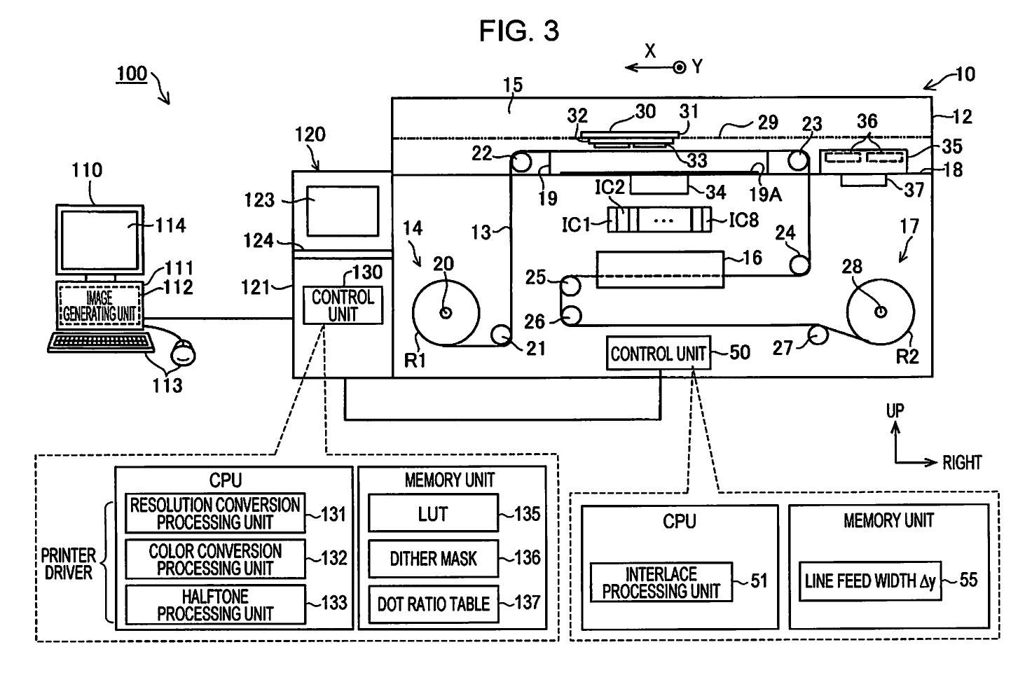

FIG. 3 is a view illustrating a schematic configuration of a printing system provided with a recording apparatus according to an embodiment of the invention. A printing system 100 is provided with an image generating device 110, a host device 120, and a printer 10. In this embodiment, the host device 120 and the printer 10 function as the “recording apparatus” in cooperation with each other. The recording apparatus (the host device 120 and the printer 10) of this embodiment restricts the occurrence of banding unevenness on a recording medium by having a configuration which will be described later.

The image generating device 110 generates image data and transmits the generated image data to the host device 120. The host device 120 generates printing data based on the image data received from the image generating device 110, and transmits the generated printing data to the printer 10. The printer 10 prints an image indicated by the image data by forming dots onto the recording medium based on the printing data received from the host device 120.

The image generating device 110 is configured of, for example, a personal computer. The image generating device 110 is provided with a main body 111, an image generating unit 112, an input device 113, and a monitor 114. The main body 111 includes a memory unit, which stores a program for creating an image, and a CPU. The input device 113 is, for example, an input device such as a keyboard and a mouse. The monitor 114 is, for example, a display device such as a liquid crystal display, and displays a graphical user interface (GUI) screen (menu screen and the like) for a user to operate the image generating device 110 and a GUI screen for the user to create and edit an image, which is a printing target.

The image generating unit 112 is a functional unit realized by the program for creating an image within the memory unit being executed by the CPU of the main body 111. The image generating unit 112 controls the display of the GUI screen for creating and editing an image to be displayed onto the monitor 114. Accordingly, the user can create an image for printing through the GUI screen to be displayed onto the monitor 114 by starting the image generating unit 112 and operating the input device 113. For example, in a case where the image for printing is a label to be attached onto a product, the user can create a plurality of frame images on which a plurality of label images are vertically and horizontally disposed. After then, the user instructs, from the input device 113, that the plurality of created frame images be printed. Then, the image generating unit 112 transmits image data indicating the plurality of created frame images to the host device 120 via a communication interface. Instead of creating an image, the image data stored in the recording medium may be directly read by the image generating device 110 or the host device 120.

The host device 120 is configured of, for example, a personal computer. The host device 120 is provided with a main body 121, a monitor 123, an operating unit 124, and a control unit 130. The main body 121 is a housing that accommodates each unit of the host device 120. The monitor 123 is a display device, for example, a liquid crystal display, and displays a GUI screen (menu screen and the like) for the user to operate the host device 120 and a GUI screen that shows an image, which is a printing target.

The control unit 130 includes a CPU and a memory unit. In addition to controlling (for example, controlling the display of the aforementioned GUI screen) each unit of the host device 120 by executing a computer program (not illustrated) within the memory unit, the CPU functions as a resolution conversion processing unit 131, a color conversion processing unit 132, and a halftone processing unit 133. The resolution conversion processing unit 131, the color conversion processing unit 132, and the halftone processing unit 133 function as a printer driver that generates printing data based on image data and transmits the printing data to the printer 10. A lookup table (LUT) 135 indicating a conversion correlational relationship between a display color system and a printing color system, a dither mask 136, and a dot ratio table 137 indicating a ratio of S dots, M dots, and L dots formed by a recording unit 30 are stored in advance in the memory unit.

The resolution conversion processing unit 131 converts the resolution of the image data acquired from the image generating device 110 from display resolution to printing resolution. The color conversion processing unit 132 executes color conversion from the display color system (for example, a RGB color system and a YCbCr color system) to the printing color system (for example, a CMYK color system), using the LUT 135. Based on a known systematic dither method, the halftone processing unit 133 converts pixel data having a high number of display shades (for example, 256 shades) to pixel data having a low number of printing shades (for example, four shades), using the dither mask 136 and the dot ratio table 137. In this embodiment, the halftone processing unit 133 generates pixel data in four shades, in which no dots are formed, small (S) dots are formed, medium (M) dots are formed, and large (L) dots are formed. Instead of the systematic dither method, the halftone processing unit 133 may execute shade conversion using an error diffusion method and the like.

For example, management information regarding a printing target (for example, a label to be attached to a product) can be input and printing conditions can be set on the menu screen. The management information includes, for example, an item number of a product and a lot number, a distinction between a front side printing and a back side printing in a case of double-sided printing. The printing conditions include, for example, the type and size of a printing medium and the number of prints. The type of the printing medium includes a paper type such as high quality paper, cast-coated paper, art paper, and coated paper and a film type such as synthetic paper, PET, and PP. As the size of the printing medium, a roll width is adopted in a case of this embodiment where using a roll around which a long printing medium is wound is assumed. The printing quality includes a plurality of types of printing modes (printing resolution and a recording system are determined according to a printing mode) determined in advance. Instead of the printing mode, the printing resolution and the recording system may be directly designated. In a case where a plurality of prints (images) are superimposed and printed in the same area of the printing medium, the number of images is set as the number of prints. In a case where the plurality of prints are set, an image for each print can be displayed onto the monitor 123.

### Configuration of Printer

The printer 10 of this embodiment is a so-called ink jet printer that forms dots through an interlace system. The printer 10 is provided with a main body case 12, a reeling-out unit 14, a printing chamber 15, a drying device 16, a winding unit 17, a first roller 21 to a seventh roller 27, ink cartridges IC1 to IC8, and a control unit 50. In the following description, directions indicated by arrows in FIG. 3 will be referred to as “right and left” and “up and down” as reference. In addition, the front side of the page of FIG. 3 will be referred to as “front” and the inside of the page will be referred to as “rear”.

The main body case 12 is a housing that accommodates each unit of the printer 10. The main body case 12 includes a flat plate-shaped base 18 that vertically partitions the inside of the housing.

A sheet 13, which is an example of the recording medium, is reeled out from the reeling-out unit 14 feeds. Inside the main body case 12, the reeling-out unit 14 is disposed at a position below the base 18 and to the left of the base 18. The first roller 21 to the seventh roller 27 guide the sheet 13. The winding unit 17 winds the dried sheet 13. Inside the main body case 12, the winding unit 17 is disposed at a position below the base 18 and to the right of the base 18. That is, in the printer 10 of this embodiment, the sheet 13 is transported from the left side of the housing, on which the reeling-out unit 14 is disposed, to the right side of the housing, on which the winding unit 17 is disposed. Therefore, hereinafter, the left side of the housing on which the reeling-out unit 14 is disposed will be referred to as an “upstream side” and the right side of the housing will be referred to as a “downstream side” in a transporting direction of the sheet 13.

The printing chamber 15 prints the image indicated by the image data by ejecting inks (droplets) and forming dots onto the reeled out sheet 13. Inside the main body case 12, the printing chamber 15 is disposed in a region above the base 18. The printing chamber 15 includes a rectangular plate-shaped support base 19 for supporting a printing area of the sheet 13. The support base 19 is disposed at a position corresponding to substantially the middle of the base 18 in a state of being supported by the base 18. The drying device 16 is a drying furnace that dries the sheet 13 on which the inks are attached. The drying device 16 is disposed between the reeling-out unit 14 and the winding unit 17 and above the reeling-out unit 14 and the winding unit 17.

The reeling-out unit 14 includes a winding shaft 20. The winding shaft 20 is a shaft that can be rotation-driven. The sheet 13 (hereinafter, referred to as a “roll R1”) wound into a roll is supported by the winding shaft 20 so as to integrally rotate with the winding shaft 20. That is, the sheet 13 is reeled out from the roll R1 by the winding shaft 20 being rotated.

The first roller 21 to the seventh roller 27 are shafts to guide the sheet 13 reeled out from the reeling-out unit 14 to the winding unit 17 via the printing chamber 15 and the drying device 16. The first roller 21 is disposed to the right of the reeling-out unit 14. The second roller 22 is disposed to the left of the support base 19, and the third roller 23 is disposed to the right of the support base 19. The fourth roller 24 is disposed to the right of the drying device 16, and the fifth roller 25 is disposed to the left of the drying device 16. The sixth roller 26 is disposed below the fifth roller 25. The seventh roller 27 is disposed to the left of the winding unit 17. By the sheet 13 being wound around the first roller 21, the transporting direction of the sheet 13 reeled out from the reeling-out unit 14 is converted to a vertically upward direction. After then, by the sheet 13 being wound around the second roller 22 from the lower left, the transporting direction of the sheet 13 is converted to a horizontally right direction and the sheet 13 comes into sliding contact with an upper surface of the support base 19. By the sheet 13 being wound around the third roller 23 from the upper right, the transporting direction of the sheet 13 transported from the upper surface of the support base 19 to the right is converted to a vertically downward direction. After then, by the sheet 13 being wound around the fourth roller 24, the transporting direction of the sheet 13 is converted to a horizontally left direction and the sheet 13 passes through the inside of the drying device 16. By the sheet 13 being wound around the fifth roller 25 from the upper left, the transporting direction of the sheet 13 passed through the inside of the drying device 16 is converted to the vertically downward direction. After then, the sheet 13 is guided to the winding unit 17 by the sixth roller 26 and the seventh roller 27.

The winding unit 17 includes a winding shaft 28. The winding shaft 28 is a shaft that can be rotation-driven based on a driving force of a transporting motor (not illustrated). The sheet 13 (hereinafter, referred to as a “roll R2”) wound into a roll is supported by the winding shaft 28. That is, the sheet 13 is wound into the roll R2 by the winding shaft 28 being rotated.

A die cutting processor for die-cutting a printed portion of the sheet 13 may be provided in the middle of the transporting path of the aforementioned sheet 13 (for example, between the drying device 16 and the winding unit 17).

The printing chamber 15 includes guide rails 29 (FIG. 3: two-dot chain line) and the recording unit 30, which is an example of a recorder. The guide rails 29 are a pair of rails that guide the movement of the recording unit 30 in a main scanning direction. The guide rails 29 in the front and rear of the support base 19 are disposed so as to stretch in a right-and-left direction.

The recording unit 30 ejects the inks onto the sheet 13. The recording unit 30 includes a rectangular carriage 31, a support plate 32, and a recording head 33, which is an example of a recorder. The carriage 31 is supported in a state of being capable of reciprocating in a main scanning direction X (the right-and-left direction in FIG. 3) along the both guide rails 29 based on the driving of a carriage motor. Furthermore, the carriage 31 is supported in a state of being capable of reciprocating in a sub-scanning direction Y (a front/rear direction orthogonal to the page of FIG. 3) along another guide rail (not illustrated). As a result, the recording unit 30 can move in the two directions, one being the main scanning direction X (second direction) and the other being the sub-scanning direction Y (first direction). In the printer 10 of this embodiment, a scanner is realized by the guide rails 29, and a line feeder is realized by another guide rail. The support plate 32 is provided on a lower surface side of the carriage 31, and holds a plurality of recording heads 33. Details will be described later.

In the printing chamber 15, a regular area over substantially the entire region on the upper surface of the support base 19 is a printing region. The sheet 13 is intermittently transported by the printing area corresponding to the printing region. Furthermore, a suction device 34 is provided below the support base 19. The suction device 34 is driven such that a negative pressure is exerted to multiple suction-holes (not illustrated) that open on the upper surface of the support base 19, and the sheet 13 is adsorbed onto the upper surface of the support base 19 by a suction force caused by the negative pressure. One printing area on the sheet 13 is printed by main scanning (relative movement between the recording unit 30 and the sheet 13 in the second direction), in which the recording unit 30 is moved in the main scanning direction X and the inks are ejected from the recording head 33, and sub-scanning (relative movement between the recording unit 30 and the sheet 13 in the first direction), in which the recording unit 30 is moved in the sub-scanning direction Y and the recording unit 30 is disposed at the next main scanning position, being alternately performed. Once the one printing area is printed, the negative pressure of the suction device 34 is released and the adsorption of the sheet 13 onto the support base 19 is released. After then, by the sheet 13 being transported and the sheet 13 before printing being disposed onto the support base 19, the printing area on the sheet 13 is changed from the one printing area to the next printing area. That is, in the printer 10 of this embodiment, the printing area on the sheet 13 is changed by the sheet 13 being transported.

Each of the ink cartridges IC1 to IC8 accommodates different colors of inks (liquids). The ink cartridges IC1 to IC8 are detachably mounted inside the housing of the main body case 12. In the printer 10 of this embodiment, each of the ink cartridges IC1 to IC8 accommodates black (K), cyan (C), magenta (M), yellow (Y), white (W), and clear (transparent ink for overcoating) inks, respectively. The type of the ink and the number of colors can be appropriately set. In addition, a cartridge that accommodates a moisturizing liquid for maintenance may be further provided, in addition to the inks for printing. Each of the ink cartridges IC1 to IC8 is connected to the recording head 33 through an ink supplying path (not illustrated). Each of the recording heads 33 ejects the ink supplied from each of the ink cartridges IC1 to IC8 onto the sheet 13.

Furthermore, a maintenance device 35 that maintains the recording head 33 at a time of non-printing is disposed on a right end side within the printing chamber 15. The maintenance device 35 includes a cap 36 and a lift device 37. The recording head 33 of the recording unit 30 that stands by at a home position at a time of non-printing is capped by the cap 36 raised by the lift device 37 being driven, thereby avoiding the thickening of the inks within nozzles. In addition, when a predetermined maintenance time comes, a suction pump (not illustrated) of the maintenance device 35 under a state of being capped is driven and the inside of the cap 36 comes under a negative pressure. Accordingly, the inks are forcibly discharged from the nozzles of the recording head 33, and thus the thickening of the inks within the nozzles and the bubbles in the inks can be eliminated.

Furthermore, a heater 19A that heats the support base 19 to a predetermined temperature (for example, 40 to 60° C.) is provided on a lower surface of the support base 19. The sheet 13 is dried first on the support base 19 by the heater 19A and is dried again by the drying device 16.

The control unit 50 includes a CPU and a memory unit. In addition to controlling each unit of the printer as the control unit 50 by executing a computer program (not illustrated) within the memory unit, the CPU functions as an interlace processing unit 51. The interlace processing unit 51 forms each of dots onto the sheet 13 by causing the recording head 33 to discharge the inks in accordance with the interlace system (system in which the second and subsequent raster lines are formed such that a clearance of each of the raster lines formed on the sheet 13 is buried by the first main scanning). Herein, the “raster line” means a dot row (that is, the dot row in the main scanning direction) that is arranged in a row in the main scanning direction. In addition, the control unit 50 controls a transporting operation, an adsorbing operation, and an adsorption releasing operation, all of which required for printing. The transporting operation is an operation of transporting the sheet 13 by the transporting motor (not illustrated) being driven. The adsorbing operation is an operation of adsorbing the sheet 13 on the upper surface of the support base 19 by the suction device 34 being driven. The adsorption releasing operation is an operation of releasing the adsorption of the sheet 13 onto the support base 19 by the driving of the suction device 34 being released.

### Configuration of Recording Unit

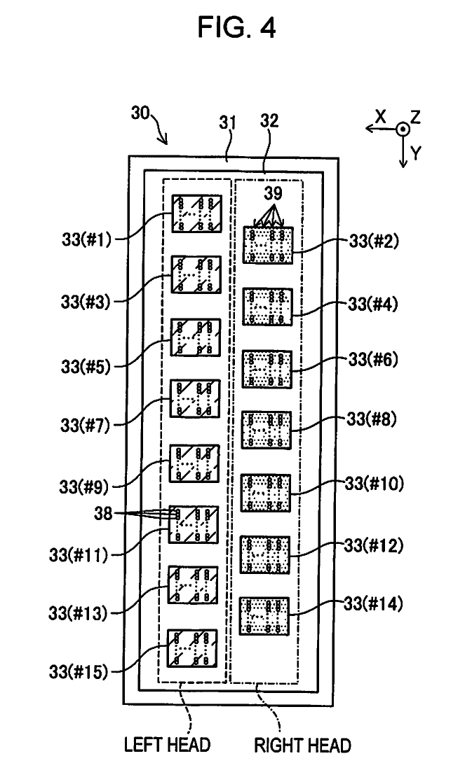

FIG. 4 is a view illustrating a configuration of the recording unit 30. FIG. 4 illustrates the configuration of a bottom surface side (a direction in which a lower side faces an upper side in FIG. 3) of the recording unit 30. In FIG. 4, an arrow to which X is attached corresponds to the main scanning direction X (the right-and-left direction in FIG. 3) of the recording unit 30 and an arrow to which Y is attached corresponds to the sub-scanning direction Y (the front/rear direction orthogonal to the page of FIG. 3) of the recording unit 30. In addition, a direction orthogonal to both directions of the main scanning direction X and the sub-scanning direction Y will be referred to as a depth direction Z. Hereinafter, the length of the recording unit 30 in the main scanning direction X will be referred to as “the width of the recording unit 30”, and the length of the recording unit 30 in the sub-scanning direction Y will be referred to as “the height of the recording unit 30”.

The support plate 32 is supported by a bottom surface side (the direction in which the lower side faces the upper side in FIG. 3) of the carriage 31 attached to the recording unit 30. The P (P is a natural number that is equal to or greater than 2, and P=15 in this embodiment) recording heads 33 are supported in a zigzag disposition pattern by the support plate 32 in the main scanning direction X and the sub-scanning direction Y. Hereinafter, in a case where each of the recording heads 33 is distinguished and described, the heads will also be referred to as the first head (FIG. 4: #1), the second head (FIG. 4: #2) . . . , and the fifteenth head (FIG. 4: #15) in order of the upper side (upper side of FIG. 4) to the lower side in the sub-scanning direction Y. A plurality of nozzle rows 39 (eight rows in this embodiment) are disposed at a predetermined interval in the main scanning direction X on a bottom surface side (direction in which the lower side faces the upper side in FIG. 3) of each of the recording heads 33. Each of the nozzle rows 39 includes a plurality of nozzles 38 placed at a regular nozzle pitch (nozzle interval) in the sub-scanning direction Y. Each of the nozzle rows 39 receives the ink supplied from one ink cartridge corresponding to each of the eight ink cartridges IC1 to IC8 and ejects each of the different types of inks from the nozzles 38.

In this embodiment, “zigzag” disposition means a disposition satisfying all of the following conditions a1 to a3.

(a1) N (n is a natural number that is equal to or greater than 2) recording heads 33 are disposed in the main scanning direction X (that is, a width direction of the recording unit 30).

(a2) M sets (m is a natural number that is equal to or greater than 1) of n recording heads 33 are disposed in the sub-scanning direction Y (that is, a height direction of the recording unit 30). Less than n recording heads 33 that do not meet condition a2 may be further disposed in the recording unit 30.

(a3) The n recording heads 33 are disposed such that positions thereof in the sub-scanning direction Y are shifted away from each other in a manner that a part of an area occupied by the nozzles 38 disposed in the sub-scanning direction Y within any one of the recording head 33 and a part of an area occupied by the nozzles 38 disposed in the sub-scanning direction Y within the other one of the recording head 33 overlap each other.

In an example of FIG. 4, two recording heads 33 (#1 and #2) are disposed in the main scanning direction X and thus the condition al is satisfied. In addition, the condition a2 is satisfied since seven sets (#1 and #2, #3 and #4, #5 and #6, #7 and #8, #9 and #10, #11 and #12, and #13 and #14) of two recording heads 33 disposed in the main scanning direction X are disposed in the sub-scanning direction Y. That is, n=2 and m=7 in the example of FIG. 4. In the example of FIG. 4, one recording head 33 (#15) that does not meet the condition a2 is further disposed in the recording unit 30. As a result, fifteen recording heads in total are disposed in the recording unit 30, as in the aforementioned description.

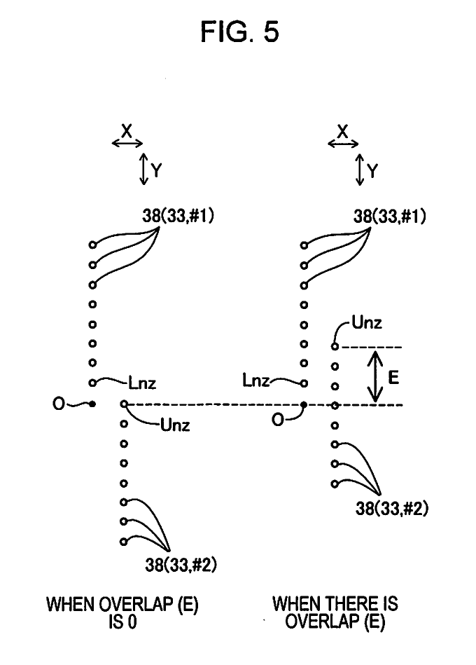

FIG. 5 is a view illustrating the condition a3. In FIG. 5, each of the nozzles 38 included in one nozzle row 39 of the first head (#1) and each of the nozzles 38 included in one nozzle row 39 of the second head (#2) are extracted and illustrated. As described in the condition a3, in the recording unit 30 of this embodiment, each of the recording heads 33 is disposed such that a part of an area occupied by the nozzles 38 disposed in the sub-scanning direction Y within any one of the recording heads 33 (first head in an example of FIG. 5) and a part of an area occupied by the nozzles 38 disposed in the sub-scanning direction Y within the other recording head 33 (second head in the example of FIG. 5) overlap each other. That is, the recording heads 33 in the recording unit 30 of this embodiment are disposed as in a configuration illustrated on the right in the FIG. 5. In other words, in the recording unit 30 of this embodiment, each of the recording heads 33 is disposed such that a part of the area of the nozzles 38 within one recording head 33 (first head in the example of FIG. 5) and a part of the area of the nozzles 38 within the other recording head 33 (second head in the example of FIG. 5) that are adjacent to each other in the main scanning direction X overlap each other in the sub-scanning direction Y.

Herein, the amount of overlap of the areas of the nozzles 38 within the two recording heads 33 in the sub-scanning direction Y is also referred to as an “overlap amount E”. When an origin O is set to a position one nozzle pitch outside the nozzle 38 (lowermost nozzle Lnz in FIG. 5) at an end portion of the first head on a second head side in the sub-scanning direction Y among the nozzles 38 of the first head, the overlap amount E in this embodiment indicates how many nozzle pitches the nozzle 38 (uppermost nozzle Unz) at an end portion of the second head on a first head side in the sub-scanning direction Y among the nozzles 38 of the second head has moved to the first head side in the sub-scanning direction Y from the position of the origin O. In a case where the nozzle 38 is at a position which is the same as the position of the origin O or at a position on the outside of the origin O, the overlap amount is 0. For example, in a configuration illustrated on the left in FIG. 5, the overlap amount is 0 since the uppermost nozzle Unz of the second head (#2) is at a position that is the same as the position of the origin O in the sub-scanning direction Y. In addition, in the configuration on the right in FIG. 5, the overlap amount is 3 since the uppermost nozzle Unz of the second head (#2) is at a position three nozzle pitches away to the first head side in the sub-scanning direction Y from the origin O. The overlap amount E can be set or changed to any value by changing positions at which the first head and the second head are disposed according to image quality required for the printer 10 and the design of the recording head 33.

Hereinafter, in the recording unit 30 illustrated in FIG. 4, among the plurality of recording heads 33 disposed in zigzags, an aggregation of the recording heads 33 disposed on the right will be referred to as a “right head” and an aggregation of the recording heads 33 disposed on the left will be referred to as a “left head”. In FIG. 4, the right head is dot-hatched and is framed in a one-dot chain line, and the left head is obliquely hatched and is framed with a dashed line.

### Printing Operation

An operation when the recording unit 30 of this embodiment forms dots will be described. The printer 10 completes the forming of dots onto one printing area of the sheet 13 by the recording unit 30 executing the “main scanning”, in which dots are formed onto the sheet 13, M times while moving in the main scanning direction X. One main scanning is also referred to as “one pass” The value of M can be set or changed to any number according to the obtained printing resolution, and M is 2 (that is, two-pass printing) in this embodiment. Hereinafter, an operation of the recording unit 30 will be described in detail.

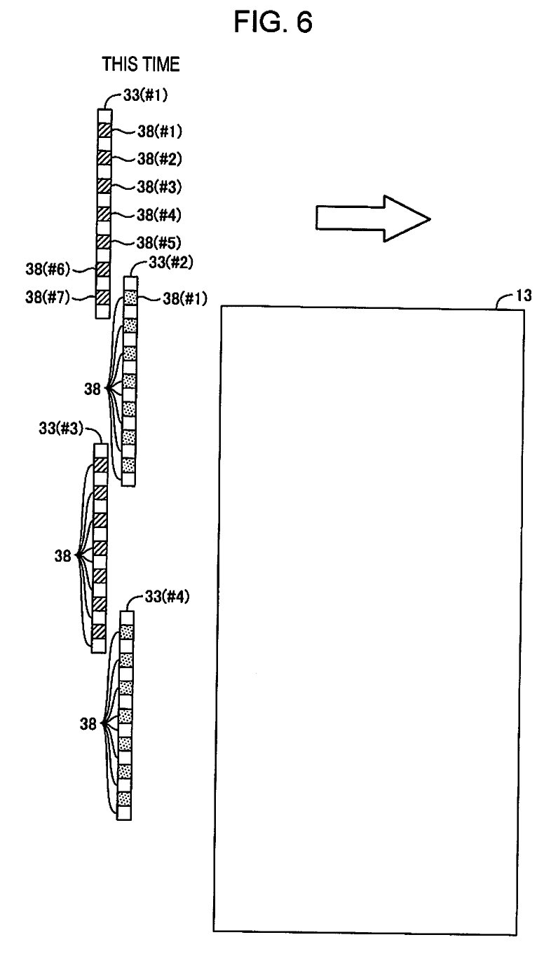

FIG. 6 to FIG. 9 are views illustrating phases in which the recording unit 30 of this embodiment forms the dots onto the sheet 13. In FIG. 6 to FIG. 9, for convenience of illustration, a case where four recording heads 33 (#1 to #4) are disposed in the recording unit 30, only one nozzle row 39 is illustrated within each of the recording heads 33, seven nozzles 38 (#1 to #7) are included in one nozzle row 39, and the overlap amount E is 1 is illustrated. Hereinafter, in a case where each of the nozzles 38 are distinguished and described, the seven nozzles are also referred to as the first nozzle (FIG. 6: 38#1), the second nozzle (FIG. 6: 38#2) . . . , and the seventh nozzle (FIG. 6: 38#7) in order of the upper side (upper side in FIG. 6 to FIG. 9) to the lower side in the sub-scanning direction Y. In addition, in FIG. 6 to FIG. 9, each of the nozzles 38 within the right head and the raster lines formed by each of the nozzles 38 within the right head are dot-hatched. Similarly, each of the nozzles 38 within the left head and the raster lines formed by each of the nozzles 38 within the left head are obliquely hatched.

FIG. 6 illustrates an example of a positional relationship between each recording head 33 and the sheet 13 before printing the first pass. As illustrated in the figure, in the printer 10 of this embodiment, before printing the first pass, the position of the recording unit 30 in the sub-scanning direction Y is set to a position where the position of an upper end of the sheet 13 is the same as the position of a lower end of the first nozzle (38#1) of the second head (33#2). That is to form raster lines by the first head (33#1) between the raster lines formed in the first pass, in the second pass of printing under the interlace system. The control unit 50 forms (that is, prints the first pass) raster lines of the first pass by causing the inks to be discharged from each of the nozzles 38 while moving the recording unit 30 in a direction of an outlined arrow from a state of FIG. 6.

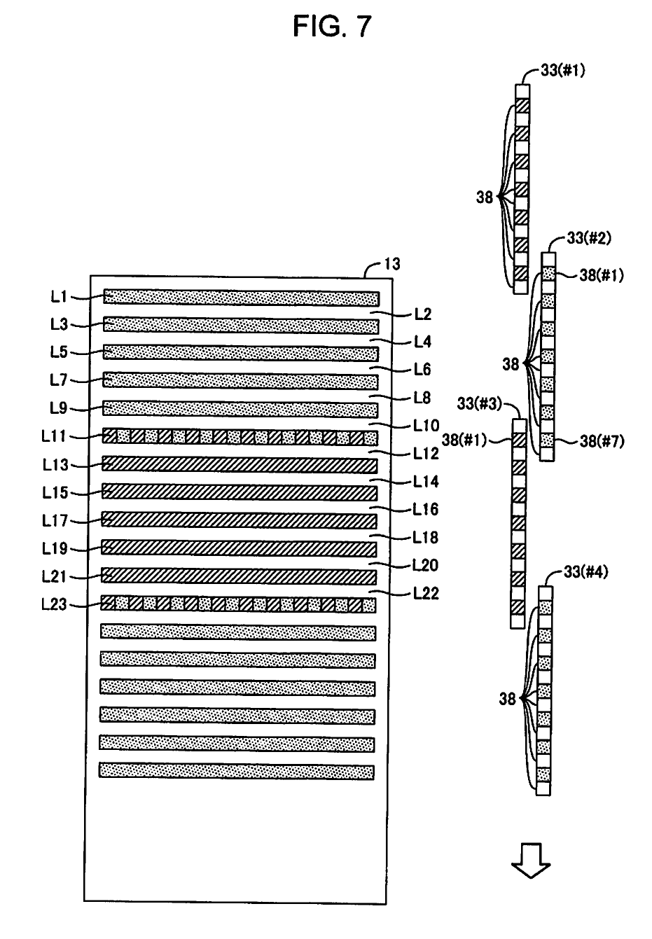

FIG. 7 illustrates an example of raster lines formed on the sheet 13 after the end of the first pass. As illustrated in the figure, in the printer 10 of this embodiment, raster lines with odd numbers (FIG. 7: Ll, L3, and the like) are formed on the sheet 13 by the printing of the first pass. Herein, each dot, for example, in raster lines L1 to L9 (odd number), is formed by the second head (33#2), which is the right head. Each dot in raster lines L13 to L21 (odd number) is formed by the third head (33#3), which is the left head. Meanwhile, each dot, for example, in a raster line L11 (odd number) corresponding to a joint between heads is formed by both heads, one being the seventh nozzle (38#7) of the second head (33#2), which is the right head, and the other being the first nozzle (38#1) of the third head (33#3), which is the left head. Herein, the joint between heads means, in other words, a portion in which the right head and the left head overlap each other.

After then, the control unit 50 executes the “sub-scanning”, in which the recording unit 30 is moved in the sub-scanning direction Y (FIG. 7: outlined arrow) by a predetermined line feed width Δy1. Herein, the control unit 50 of this embodiment sets the line feed width Δy1 to a regular size that satisfies the following Equation 1. The “regular size” means that the line feed width Δy1 of the sub-scanning executed between the first main scanning and the second main scanning is made the same as the line feed width Δy1 of the sub-scanning executed between the second main scanning and the third main scanning in a case where, for example, three or more times of main scanning are performed. The line feed width Δy1 based on Equation 1, for example, may be obtained in advance and stored (line feed width Δy 55) in the memory unit, or may be obtained at any time.

Line feed width Δy1=(Length of recording head in sub-scanning direction Y)−(width of overlap amount E in sub-scanning direction Y)±(width of one pixel in sub-scanning direction Y) (1)

The line feed width Δy1 corresponds to a “movement amount when the recording unit 30 is moved in the sub-scanning direction Y between one main scanning and the next main scanning”. In this embodiment, the units of the line feed width Δy1 and the nozzle pitch are the inch. In addition, although two solutions of the line feed width Δy1 are obtained in the above Equation 1, any value may be used as the line feed width Δy1.

The control unit 50 in this embodiment can acquire length of recording head=number of nozzles×nozzle pitch as the “length of the recording head”, using the number of the nozzles 38 included within one recording head 33 in the sub-scanning direction Y, in other words, the number of the nozzles 38 included in one nozzle row 39. In addition, as in the aforementioned description, the control unit 50 of this embodiment can acquire width of overlap amount E=overlap amount E×nozzle pitch as the “overlap amount E”, using a position (distance from the origin O in the sub-scanning direction Y) of the uppermost nozzle Unz of one recording head 33 in the sub-scanning direction Y with respect to the origin O of the other recording head 33 (the unit is the nozzle pitch) among two recording heads 33. In addition, the control unit 50 of this embodiment can acquire width of one pixel in sub-scanning direction Y=1 (inch)/printing resolution (dpi) in sub-scanning direction Y as the “width of one pixel in sub-scanning direction Y”, using printing resolution (dpi) in the sub-scanning direction Y. In addition, in a case where the “width of one pixel in sub-scanning direction Y” is converted into a nozzle pitch, width of one pixel in sub-scanning direction Y resolution (dpi) of nozzle of recording head/printing resolution (dpi) in sub-scanning direction Y can be acquired, using the resolution (dpi) of the nozzles of the recording heads.

The control unit 50 may obtain Δy2 by the line feed width Δy1 that satisfies Equation 1 being converted into the nozzle pitch as in the following Equation 2.

Line feed width Δy2=(Number of nozzles)−(overlap amount E)±(resolution of nozzle of recording head/printing resolution in sub-scanning direction Y) (2)

In an example of this embodiment, since the number of nozzles is 7 and the overlap amount E is 1, for example, line feed width Δy2=7−1±(resolution of nozzle of recording head/printing resolution in sub-scanning direction Y) nozzle pitch is established. Herein, in this embodiment, in a case where the resolution of the nozzle of the recording head is set to 7 (dpi) and the printing resolution in the sub-scanning direction Y is set to 14 (dpi), line feed width Δy2=7−1±(7/14)=6±0.5 nozzle pitches is satisfied.

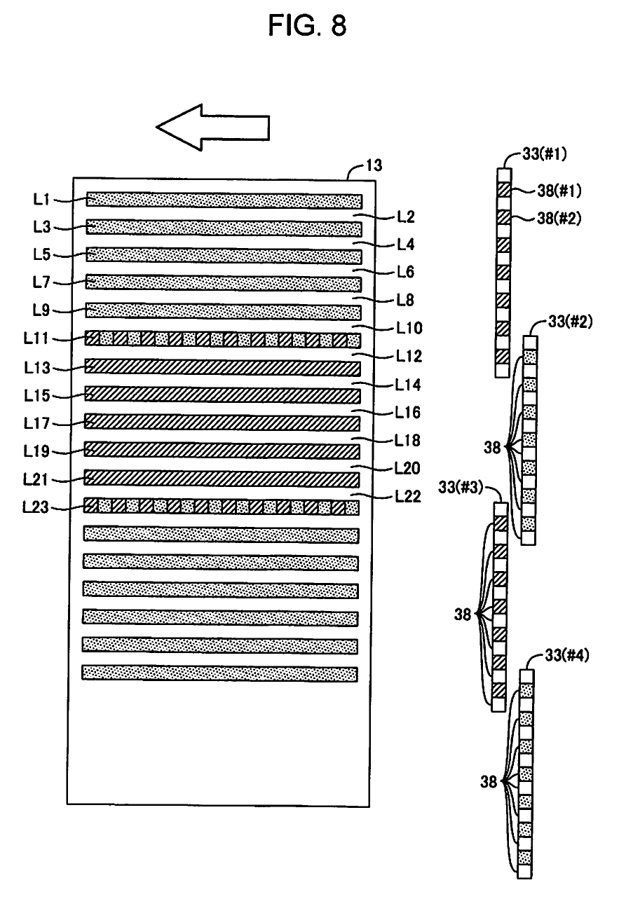

FIG. 8 illustrates an example of a positional relationship between each recording head 33 and the sheet 13 after the sub-scanning. As illustrated in the figure, for example, in a case where the nozzle 38 disposed on the upper right within each recording head 33 by the sub-scanning of the line feed width Δy2 (6.5 nozzle pitches) that satisfies Equation 2 is observed,
the position of the upper right nozzle 38 of the nth recording head 33 that performs one main scanning, for example, the position (FIG. 7) of the upper right nozzle (38#1) of the second head (33#2) that performs the first main scanning, and
the position of the upper right nozzle 38 of the n-lth recording head 33 that performs the next main scanning, for example, the position (FIG. 8) of the upper right nozzle (38#1) of the first head (33#1) that performs the second main scanning, have become positions shifted away from each other by 0.5 nozzle pitches in one of an upward direction and a downward direction in the sub-scanning direction Y with respect to the sheet 13. That applies the same to the n-2th recording head 33 in a case of the main scanning after next (third main scanning). In this way, by the sub-scanning of the line feed width Δy2 that satisfies Equation 2, each nozzle 38 within the recording unit 30 comes at a position capable of forming raster lines L2, L4, and the like with even numbers, which are yet to be formed. The control unit 50 forms (that is, prints the second pass) raster lines of the second pass by causing the inks to be discharged from each of the nozzles 38 while moving the recording unit 30 in a direction of an outlined arrow from a state of FIG. 8.

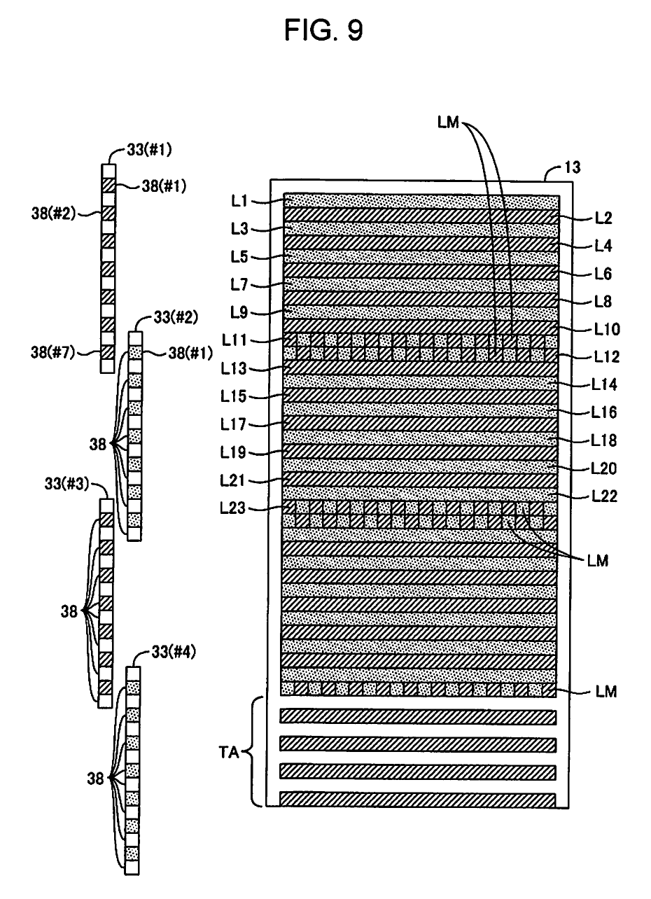

FIG. 9 illustrates an example of raster lines formed on the sheet 13 after the end of the second pass. As illustrated in the figure, in the printer 10 of this embodiment, raster lines with even numbers (FIG. 9: L2, L4, and the like) are formed on the sheet 13 by the printing of the second pass. Herein, each dot, for example, in raster lines L2 to L10 (even number), is formed by the first head (33#1), which is the left head. Each dot in raster lines L14 to L22 (even number) is formed by the second head (33#2), which is the right head. Meanwhile, each dot, for example, in a raster line L12 (even number) corresponding to a joint between heads is formed by both heads, one being the seventh nozzle (38#7) of the first head (33#1), which is the left head, and the other being the first nozzle (38#1) of the second head (33#2), which is the right head.

By the printing of the second pass, each of the raster lines illustrated in FIG. 9 is formed on the sheet 13. After the printing is executed to the second pass, the control unit 50 changes the printing area on the sheet 13 to the next printing area by performing the aforementioned adsorption releasing operation and the transporting operation. After then, the control unit 50 performs the adsorbing operation to fix a new printing area. When executing the printing of the second pass, the control unit 50 may not print a region TA consisting of raster lines formed by one of right or left recording heads 33, which is at the lower end of the sheet 13 illustrated in FIG. 9.

In a case where the printer 10 executes multiple-print printing, the printing area may be changed (the adsorption releasing operation, the transporting operation, and the adsorbing operation) by the control unit 50 after the printing operation of the aforementioned two passes, an operation of returning the recording unit 30 to an initial position (position in FIG. 6), a printing operation of the two passes for forming a second print by the recording unit, and the operation of returning the recording unit 30 to the initial position . . . being repeated. Examples of the multiple-print printing include a two-print printing in which a print of a main image and a print of an overcoat layer are printed and superimposed and three-print printing in which a print of a main image, a print of an under layer, and a print of an overcoat layer are printed and superimposed.

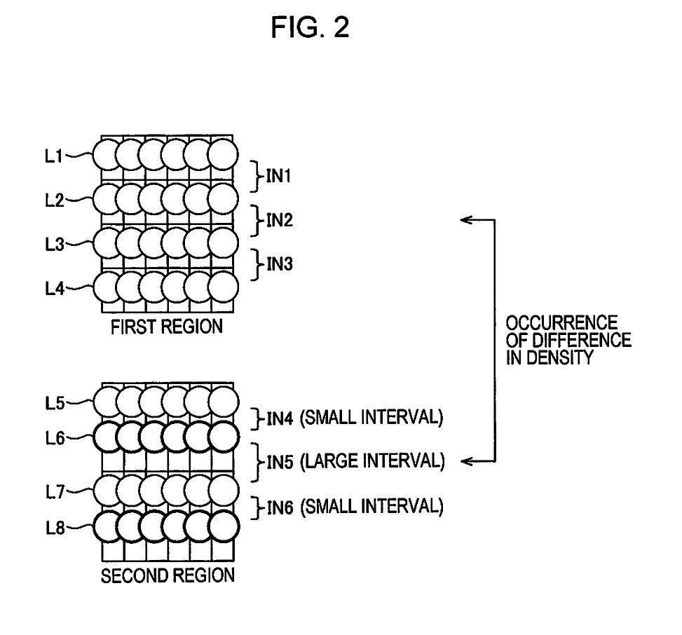

As described above, according to the recording apparatus (the printer 10 and the host device 120) of this embodiment, in a case where each of the raster lines formed on the recording medium (the sheet 13) is observed, all of the raster lines (FIG. 9: dot-hatched) formed by the right head and the raster lines (FIG. 9: obliquely hatched) formed by the left head are alternately repeated, excluding raster lines LM corresponding to the joints between heads and a raster line within the region TA which is the lower end of the sheet 13. In other words, in a case where each of the raster lines formed on the recording medium is observed, the raster lines (FIG. 9: raster lines with odd numbers) formed in one main scanning and the raster lines (FIG. 9: raster lines with even numbers) formed in the next main scanning are formed by n recording heads 33 disposed so as to be arranged in the recording unit 30 in the main scanning direction X. As a result, according to the recording apparatus of this embodiment, all regions, excluding the raster lines LM and the region TA which is the lower end of the sheet 13, are a second region (FIG. 2, lower part) including both of the raster lines formed by the nozzles 38 of the right head and the raster lines formed by the nozzles 38 of the left head, and do not include a first region (FIG. 2, upper part) including only the raster lines formed by the nozzles 38 of one of the right and the left head.

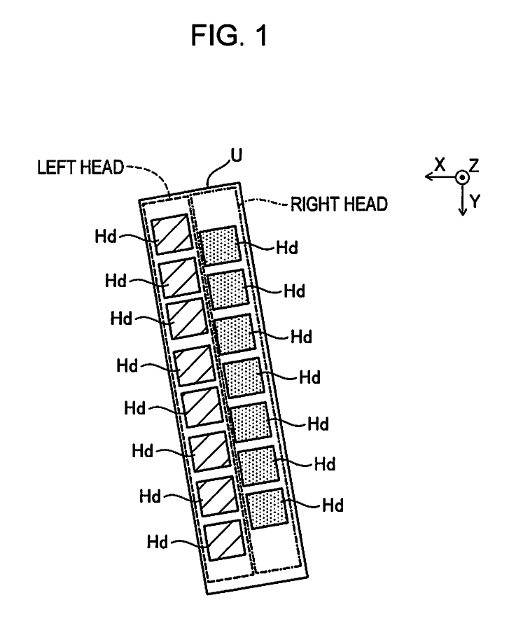

Therefore, according to the recording apparatus (the printer 10 and the host device 120) of this embodiment, even in a case where the recording unit 30 of the printer 10 is tilted about a rotation axis parallel to the depth direction Z with respect to the sub-scanning direction Y as illustrated in FIG. 1 (that is, in a case where the nozzle rows 39 of the recording head 33 are in a state of not being in parallel with the sub-scanning direction Y), banding unevenness illustrated in FIG. 2 does not occur on the sheet 13 since the first region is not included. For this reason, according to the recording apparatus of this embodiment, the plurality of recording heads 33 can restrict the occurrence of banding unevenness in the recording apparatus that prints under the interlace system, using the recording units 30 disposed in zigzags.

Furthermore, according to the recording apparatus (the printer 10 and the host device 120) of this embodiment, since the control unit 50 can consider the length of the recording head in the sub-scanning direction Y and the width of the overlap amount E in the sub-scanning direction Y in Equation 1 for obtaining the line feed width Δy1 as a reference for the “number of the nozzles 38” in Equation 2 for obtaining the line feed width Δy2 by converting the line feed width Δy1 into the nozzle pitch, the control by the control unit 50 can be simplified. In addition, since the control unit 50 obtains the line feed width Δy2 with the number of the nozzles 38, which actually contribute to the printing, as a reference, freedom in designing a portion of the recording head 33, in which the nozzles 38 are not disposed, can be improved.

In the above embodiment, blank dots attributable to an error (for example, a position shift) in manufacturing the nozzles 38 within the recording head 33 can be restricted since the raster line LM corresponding to the joint between heads, which consists of dots formed by both of the right and the left heads being used. However, the raster line LM may consist of dots formed by any of the right and the left heads being used.

### Comparative Example

Hereinafter, a comparative example will be described. A printer of the comparative example has the same configuration as that of the printer 10 of the above embodiment, excluding that the line feed width Δy2 is controlled not based on the aforementioned Equation 2. The line feed width Δy2 used in the printer of the comparative example is 2.5 nozzle pitches. Any number can be determined as the line feed width Δy2. The line feed width Δy2 may be determined in advance and stored in a memory unit, or may be determined at any time.

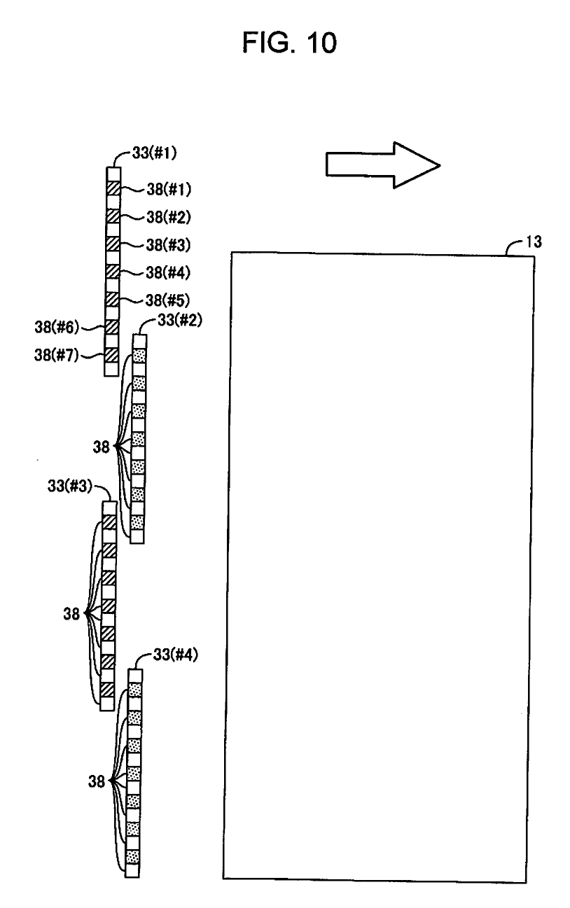

FIG. 10 to FIG. 13 are views illustrating phases in which the recording unit 30 of the related art forms the dots onto the sheet 13. In FIG. 10 to FIG. 13, a case where four recording heads 33 (#1 to #4) are disposed in the recording unit 30, only one nozzle row 39 within each of the recording heads 33 is illustrated, seven nozzles 38 (#1 to #7) are included in one nozzle row 39, and the overlap amount E is 1 is illustrated, as in FIG. 6 to FIG. 9. In FIG. 10 to FIG. 13, the way of referring to the nozzle and the ways of dot-hatching and obliquely hatching are the same as in FIG. 6 to FIG. 9.

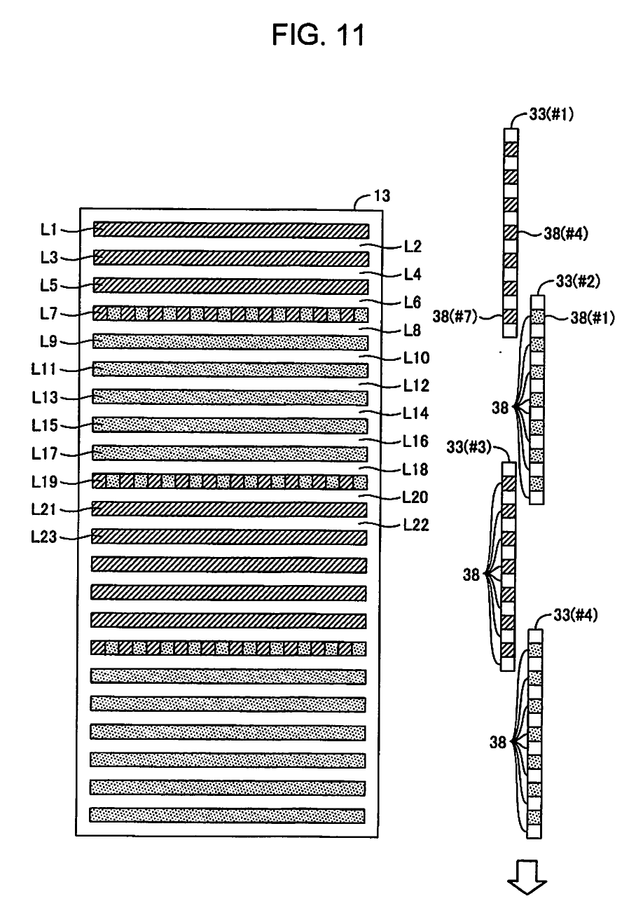

FIG. 10 illustrates an example of a positional relationship between each recording head 33 and the sheet 13 before printing the first pass. Any position may be determined according to raster lines formed on the sheet 13 as the position of the recording unit 30 in the sub-scanning direction Y before printing the first pass. FIG. 11 illustrates an example of the raster lines formed on the sheet 13 after the end of the first pass. In the printer of the comparative example as well, raster lines with odd numbers are formed by the printing of the first pass and raster lines (for example, the raster lines L7 and L19) corresponding to the joints between heads, which consist of dots formed by both of the right and the left heads being used. After then, the printer of the comparative example 10 executes the sub-scanning in which the recording unit 30 is moved in the sub-scanning direction Y (FIG. 11: outlined arrow) by a predetermined line feed width Δy2 (2.5 nozzle pitches).

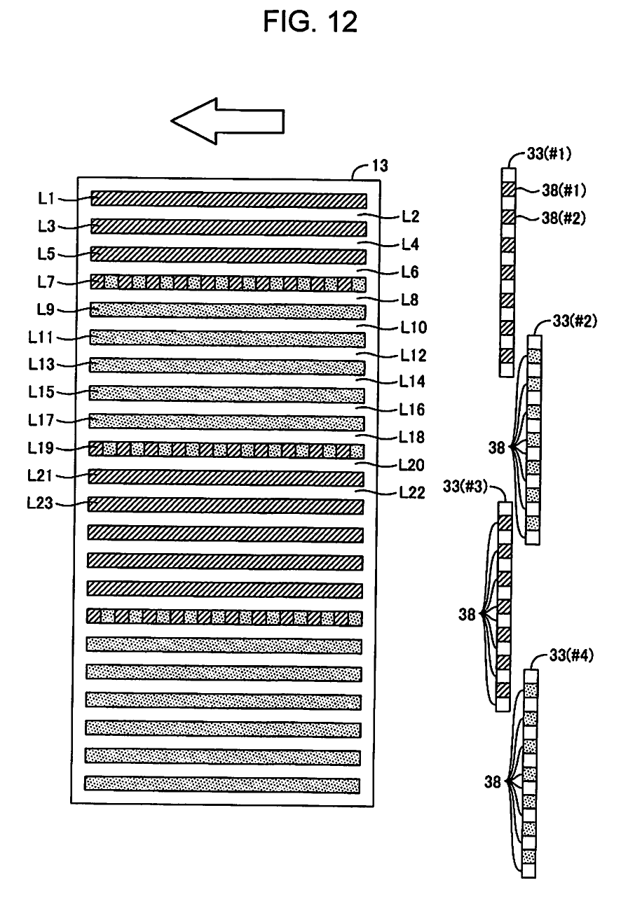

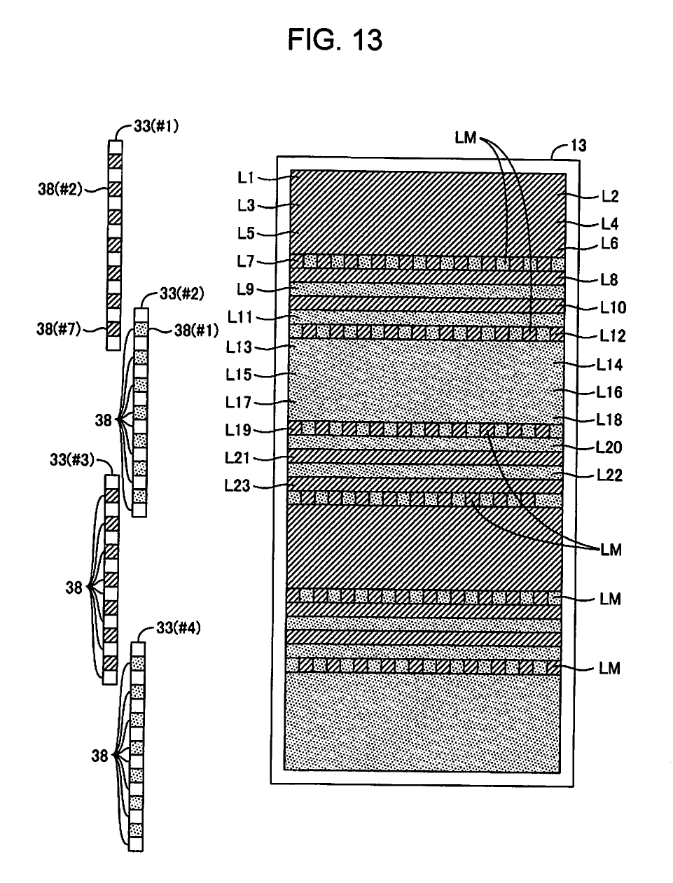

FIG. 12 illustrates an example of a positional relationship between each recording head 33 and the sheet 13 after the sub-scanning. By the sub-scanning of 2.5 nozzle pitches, each of the nozzles 38 within the recording unit 30 comes at a position capable of forming the raster lines L2, L4, and the like with even numbers, which are yet to be formed. FIG. 13 illustrates an example of the raster lines formed on the sheet 13 after the end of the second pass. In the printer of the comparative example as well, the raster lines with even numbers (FIG. 13: L2, L4, and the like) are formed by the printing of the second pass.

As illustrated in FIG. 13, in a case of the printer of the comparative example, for example, the raster lines L1 to L6 fall under the first region (FIG. 2, upper part) in which each dot is formed by the left head only. Similarly, for example, the raster lines L13 to L18 fall under the first region (FIG. 2, upper part) in which each dot is formed by the right head only. Meanwhile, the raster lines L8 to L11 and the raster lines L20 to L23 fall under the second region (FIG. 2, lower part) in which each dot is formed by both of the right and the left heads. For this reason, according to a printing system of the comparative example, the banding unevenness illustrated in FIG. 2 occurs on the sheet 13 in a case where the recording head 33 of the printer illustrated in FIG. 1 is tilted about the depth direction Z.

### Variation in Disposing Recording Head

The dispositions of the recording heads described in the above embodiment are merely examples, and the invention may adopt various forms. For example, variations listed below can be adopted.

### Variation 1

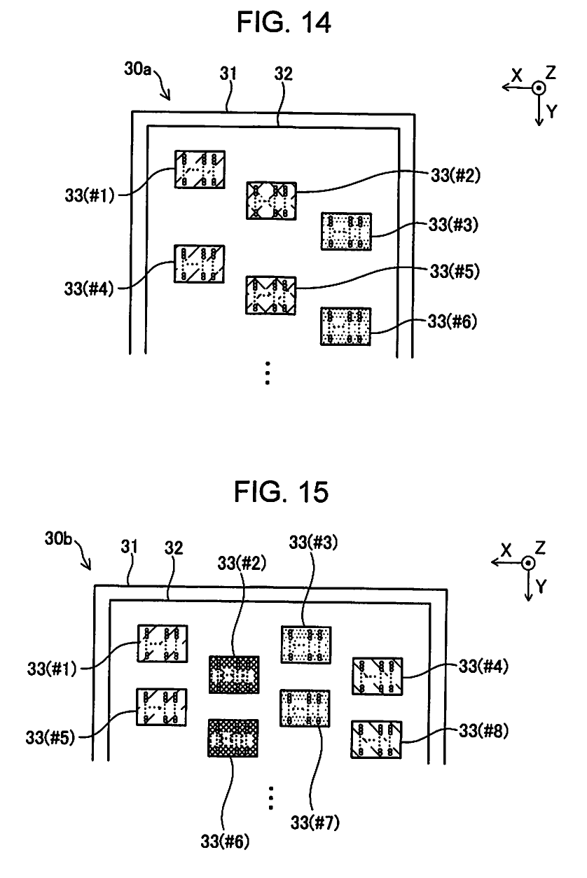

FIG. 14 is a view illustrating a configuration of a recording unit 30a in Variation 1. Instead of the recording unit 30, the printing system 100 of Variation 1 is provided with the recording unit 30a. The recording unit 30a has the same configuration as that of the recording unit 30 illustrated in FIG. 4, excluding that three recording heads 33 are disposed in the main scanning direction X (condition al). In FIG. 14, the illustration of the nozzle rows 39 is omitted. In Variation 1 as well, the control unit 50 determines the line feed width Δy2 based on the aforementioned Equation 2. For this reason, the same effects as in the above embodiment can be achieved with the configuration of Variation 1 as well.

### Variation 2

FIG. 15 is a view illustrating a configuration of a recording unit 30b in Variation 2. Instead of the recording unit 30, the printing system 100 of Variation 2 is provided with a recording unit 30b. The recording unit 30b has the same configuration as that of the recording unit 30 illustrated in FIG. 4, excluding that four recording heads 33 are disposed in the main scanning direction X (condition a1). In addition, in the recording unit 30b, the positions of the first head (FIG. 15:#1) and the third head (FIG. 15:#3) are set to the same position in the sub-scanning direction Y. Specifically, these two recording heads 33 (#1 and #3) have the nozzles 38 of which positions in the sub-scanning direction Y are the same. In addition, in recording unit 30b, the positions of the second head (FIG. 15: #2) and the fourth head (FIG. 15: #4) are also the same in the sub-scanning direction Y. In such a recording unit 30b, some recording heads 33 have the same position in the sub-scanning direction Y. In this case, however, it is assumed that the aforementioned condition a3 is satisfied. That is, the condition a3 allows the disposition of the recording heads 33 of which positions in the sub-scanning direction Y are the same and of which positions in the main scanning direction X are different from each other. In FIG. 15, the illustration of the nozzle rows 39 is omitted. In Variation 2 as well, the control unit 50 determines the line feed width Δy2 based on the aforementioned Equation 2. For this reason, the same effects as in the above embodiment can be achieved with the configuration of Variation 2 as well. In the case of the configuration of Variation 2, one raster line is divided and printed (for example, alternately) by two recording heads of which positions in the sub-scanning direction Y are the same.

### Variation 3

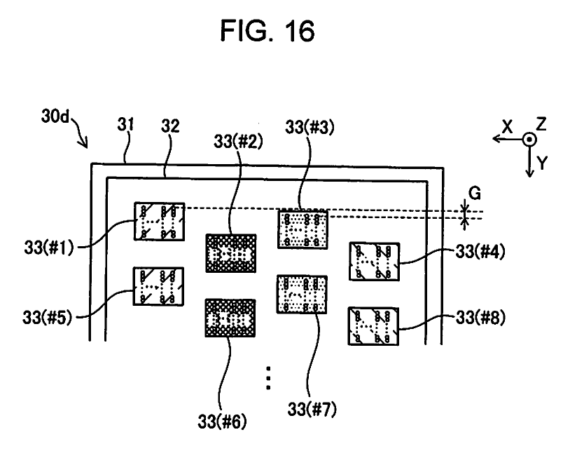

FIG. 16 is a view illustrating a configuration of a recording unit 30d in Variation 3. Instead of the recording unit 30, the printing system 100 of Variation 3 is provided with the recording unit 30d. The recording unit 30d has the same configuration as that of the recording unit 30 illustrated in FIG. 4, excluding that four recording heads 33 are disposed in the main scanning direction X (condition al). In addition, in the recording unit 30d, the first head (FIG. 16: #1) and the third head (FIG. 16: #3) are disposed so as to be at positions shifted away from each other by a predetermined gap G in the sub-scanning direction Y. In this example, G is 1/2 nozzle pitches, and for convenience of illustration, G is emphasized and written in FIG. 16. Therefore, in the recording unit 30d illustrated in FIG. 16, two recording heads 33 (#1 and #3) have the nozzles 38 of which positions are shifted away from each other by 1/2 nozzle pitches in the sub-scanning direction Y. In addition, similarly, the positions of the second head (FIG. 16: #2) and the fourth head (FIG. 16: #4) are shifted away from each other by 1/2 nozzle pitches in the sub-scanning direction Y. In FIG. 16, the illustration of the nozzle rows 39 is omitted. In the recording unit 30d disposed as described above, the first head and the third head can be considered to configure one recording head in which the number of nozzles in the nozzle rows 39 is twice the number of nozzles in the nozzle rows 39 of the first head and the nozzle pitch of the nozzle rows 39 is one half of the nozzle pitch of the nozzle rows 39 of the first head. Similarly, the second head and the fourth head can be considered to configure one recording head in which the number of nozzles in the nozzle rows 39 is twice the number of nozzles in the nozzle rows 39 of the second head and the nozzle pitch of the nozzle rows 39 is one half of the nozzle pitch of the nozzle rows 39 of the second head. In view of this, since the configuration of Variation 3 can be considered to have the same configuration as that of the recording unit 30 illustrated in FIG. 4 excluding the number of nozzles and the nozzle pitch of one head, the control unit 50 can determine the line feed width Δy2 based on the aforementioned Equation 2 in Variation 3 as well. For this reason, the same effects as in the above embodiment can be achieved in the configuration of Variation 3 as well.

### Second Embodiment

In a second embodiment of the invention, a configuration in which two line feed widths Ay are differentiated will be described. Hereinafter, only the portions having a configuration and an operation that are different from those of the first embodiment will be described. In the figures, the same configuration portions as those of the first embodiment will be assigned with the same reference signs as those of the first embodiment described before, and detailed description thereof will be omitted.

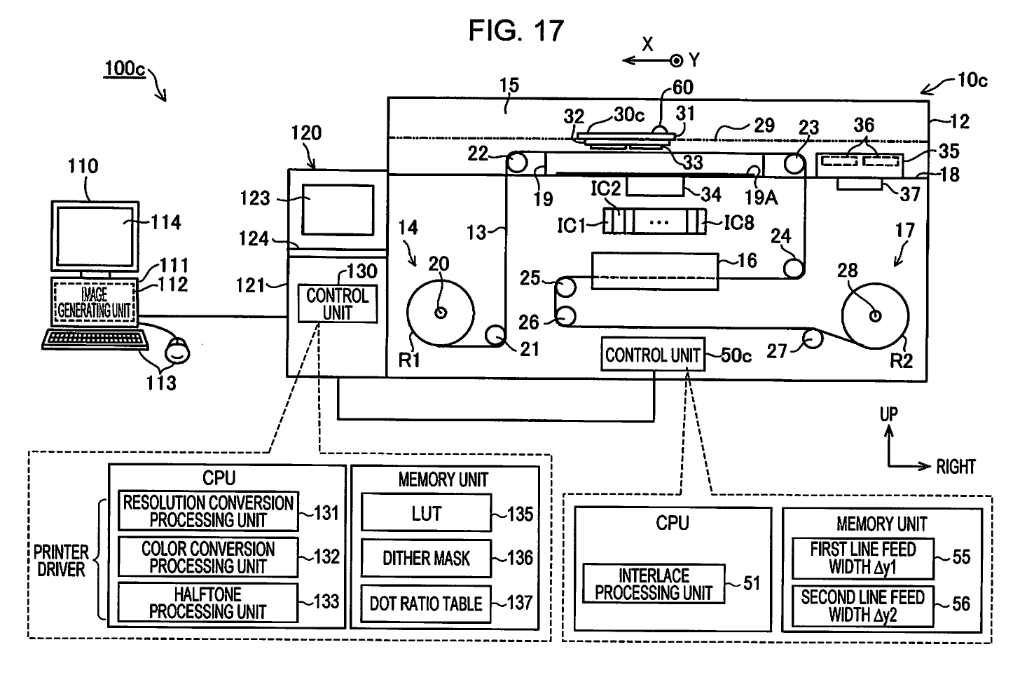

FIG. 17 is a view illustrating a schematic configuration of a printing system 100c in the second embodiment. The printing system 100c is different from the first embodiment illustrated in FIG. 3 in that a printer 10c is provided instead of the printer 10. Instead of the recording unit 30, the printer 10c is provided with a recording unit 30c. In addition to each configuration described in FIG. 4, the recording unit 30c is further provided with a tilt detection unit 60. The tilt detection unit 60 can be realized, for example, by an acceleration sensor, a magnetic sensor, and the like.

In addition, two line feed widths Δy (first line feed width Δy3 (55) and second line feed width Δy4 (56)) are stored in advance in a memory unit of the printer 10c. The first line feed width Δy3 is a size determined based on Equation 2 as in the first embodiment, and is, for example, 6.5 nozzle pitches. On the other hand, the second line feed width Δy4 is a size determined not based on Equation 2, and is, for example, 2.5 nozzle pitches as in the comparative example. Any number can be determined as the second line feed width Δy4, and may be 1/n ×recording head length.

Furthermore, instead of the control unit 50, the printer 10c is provided with a control unit 50c. Until at least one of the following conditions c1 and c2 is detected, the control unit 50c executes the aforementioned printing operation (FIG. 10 to FIG. 13), using the same second line feed width Δy4 as in the comparative example. After at least one of the following conditions c1 and c2 is detected, the control unit 50c executes the aforementioned printing operation (FIG. 6 to FIG. 9), using the same first line feed width Δy3 as in the above embodiment.

(c1) A case where the image generating device 110, the host device 120, or the printer 10c has acquired a switching request from the user.

(c2) A case where the tilt detection unit 60 has detected that the recording unit 30c is tilted about the rotation axis parallel to the depth direction Z (FIGS. 1 and 4) at a predetermined angle or more with respect to the sub-scanning direction Y (or the main scanning direction X).

The predetermined angle can be set or changed to any angle. In addition, the control unit 50c may switch angles such that the line feed width Δy is changed from the first line feed width Δy4 to the first line feed width Δy3 in a case where the switching request according to the condition c1 is acquired again or in a case where the recording unit 30c is not detected to be tilted according to the condition c2. The same variation in the disposition of the recording head as that of the first embodiment can be adopted in the second embodiment as well.

According to the printing system 100c of the second embodiment, a pattern of the raster lines formed on the sheet 13 can be differentiated between the pattern illustrated in FIG. 9 and the pattern illustrated in FIG. 13 by taking at least one of the switching request from the user and the occurrence of tilting about the rotation axis which is not in parallel with the depth direction Z of the recording unit 30c with respect to the sub-scanning direction Y (that is, a case where the nozzle rows 39 of the recording head 33 is in a state of being in parallel with the sub-scanning direction Y) as an opportunity to switch line feed widths Δy. As a result, convenience for user improves.

The pattern of the raster lines illustrated in FIG. 9 is advantageous in that the occurrence of banding unevenness on the recording medium on which dots are formed can be restricted as described above. On the other hand, in the pattern of the raster lines illustrated in FIG. 13, the raster lines LM corresponding to the joints between heads are not adjacent to each other as is apparent from FIG. 13. Dots in the raster lines LM corresponding to the joints between heads are formed using both of the right and the left heads. For this reason, the printing unevenness on the sheet 13 is likely to occur for the raster lines LM compared to other raster lines in which dots are formed by any one of the right head and the left head. That is, the pattern of the raster lines illustrated in FIG. 13 is advantageous in that the printing unevenness on the sheet 13 can be restricted since the positions where the raster lines LM, in which such printing unevenness is likely to occur, are formed can be dispersed with respect to the sub-scanning direction Y. In the printing system 100c of the second embodiment, since the pattern for a head in use is differentiated by the condition c1 or the condition c2, the pattern for the head in use, which can improve image quality of printing, can be selected according to circumstances.

### MODIFICATION EXAMPLE

In the above embodiment, a part of a configuration realized by hardware may be replaced with software. On the contrary, a part of a configuration realized by software may be replaced with hardware. In addition, the following modifications can be made as well.

### Modification Example 1

In the above embodiment, the configuration of the printing system has been given as an example. However, any configuration can be determined as the configuration of the printing system without departing from the spirit of the invention. For example, each configuration unit can be added, deleted, and converted.

The allocation of configuration elements with respect to the image generating device, the host device, and the printer in the above embodiment is merely example, and various forms can be adopted. For example, the following forms may be adopted.

(1) A form in which a part of the function of the host device is provided in the printer. In this case, all of the functions of the printer driver (the resolution conversion processing unit, the color conversion processing unit, and the halftone processing unit) and various types of information (the LUT, the dither mask, and the dot ratio table) required for realizing the functions of the printer driver are provided in the printer.

(2) A form in which a part of the function of the printer is provided in the host device. In this case, all of the function of the interlace processing unit and various types of information (for example, the line feed width Δy) required for realizing the function of the interlace processing unit are provided in the host device.

(3) A form in which overlapping functions of each of the host device and the printer overlap are provided. In this case, each of the host device and the printer is provided with
the functions of the printer driver (the resolution conversion processing unit, the color conversion processing unit, and the halftone processing unit),
various types of information (the LUT, the dither mask, and the dot ratio table) required for realizing the functions of the printer driver,
the function of the interlace processing unit, and
various types of information (for example, the line feed width Δy) required for realizing the function of the interlace processing unit. The printing system may determine which one of resolution conversion processing, color conversion processing, halftone processing, and printing processing based on the interlace system is to be executed by which device according to a predetermined condition or a request from the user and may switch processing. The predetermined condition includes, for example, data amount and printing resolution. Specifically, for example, in a case where the amount of image data is large (or in a case where the printing resolution is low), the printing system can cause the host device to execute the resolution conversion processing to the halftone processing and cause the printer to execute the printing processing based on the interlace system. In general, the data amount increases after the processing compared to the amount of image data. That is because a communication load between the host device and the printer increases once the host device executes the printing processing based on the interlace system in a case where the amount of image data is large. In addition, for example, the printing system can cause the host device to execute all types of processing in a case where the amount of image data is small (or in a case where the printing resolution is high). In general, the CPU of the host device has better processing speed compared to the CPU of the printer. For this reason, total processing time can be reduced in a case where the host device executes all types of processing.

The configuration of the recording unit in the above embodiment is merely an example, and various forms can be adopted. For example, in the recording unit illustrated in FIG. 4, the positions of a group of recording heads that configure the right head and the positions of a group of recording heads that configure the left head may be revered in the sub-scanning direction Y. In addition, in the recording unit of Variation 1 illustrated in FIG. 14, any positions can substitute for the positions of the left head (#1 and #4), the middle head (#2 and #5), and the right head (#3 and #6) in the sub-scanning direction. Similarly, in the recording heads of Variations 2 and 3 illustrated in FIG. 15 and FIG. 16 as well, any positions can substitute for the positions of heads in each row in the sub-scanning direction.

### Modification Example 2

In the above embodiment, the printing processing based on the interlace system has been given as an example. However, the procedures of the processing described in the above embodiment are merely examples, and various modifications can be made. For example, a part of the procedures may be omitted, or other procedures may be further added. The order of executing the procedures may be changed.

In the printing processing based on the interlace system in the above embodiment, the control unit has adopted the line feed width Δy1 based on Equation 1 or the line feed width Δy2 based on Equation 2 for all raster lines formed on the recording medium. However, the control unit may adopt the line feed width Δy1 based on Equation 1 or the line feed width Δy2 based on Equation 2 for a part of raster lines formed on the recording medium.

### Modification Example 3

The invention is not limited to the aforementioned embodiments, examples, and modification examples, and can be realized by various configurations without departing from the spirit of the invention. For example, the technical characteristics of the embodiments, examples, and modification examples corresponding to the technical characteristics of each form described in Summary can be appropriately substituted and combined to solve a part of or the whole of the aforementioned problems or to achieve a part of or the whole of the aforementioned effects. In addition, the technical characteristics can be appropriately deleted unless the technical characteristics are described to be required in this specification.

This application claims priority under 35 U.S.C. §119 to Japanese Patent Application No. 2016-053332, filed Mar. 17, 2016. The entire disclosure of Japanese Patent Application No. 2016-053332 is hereby incorporated herein by reference.

What is claimed is:

1. A recording apparatus comprising:
a recording unit that includes a plurality of nozzles disposed at a regular nozzle interval in a first direction and has a plurality of recording heads which discharge a liquid from the nozzles and form dots onto a recording medium;
a carriage that moves the recording unit with respect to each of the first direction and a second direction orthogonal to the first direction; and
a control unit that controls a movement of the recording unit and a formation of the dots performed by each of the nozzles based on an interlace system,
wherein, in the recording unit, n (n is a natural number that is equal to or greater than 2) recording heads as the plurality of recording heads are disposed in the second direction, m (m is a natural number that is equal to or greater than 1) sets of the n recording heads are disposed in the first direction, and the n recording heads are disposed such that positions thereof in the first direction are shifted away from each other in a manner that an area occupied by the nozzles disposed within any one of the recording heads in the first direction and an area occupied by the nozzles disposed within the other one of the recording heads in the first direction overlap each other by a predetermined overlap amount, and
wherein the control unit sets a movement amount when the recording unit is moved in the first direction, between one relative movement of the recording unit to the recording medium in the second direction and the next relative movement, to a regular amount Δy=HL (HL is the length of the recording head in the first direction)−OL (OL is the width of the overlap amount in the first direction)±PL (PL is the width of one pixel of printing resolution of a print image to be recorded by the recording unit in the first direction).

2. The recording apparatus according to claim 1,
wherein the control unit uses, as the length HL of the recording head, the product of the number of the nozzles in the first direction and the nozzle interval in one nozzle row included in one of the recording heads and uses the product of an overlap amount E and the nozzle interval as the width OL of the overlap amount.

3. The recording apparatus according to claim 1,
wherein the control unit controls the movement amount based on the relationship in a case where there is a switching request from a user and controls the movement amount not based on the relationship in a case where there is no switching request from the user.

4. The recording apparatus according to claim 1, further comprising:
a tilt detection unit that detects tilting of the recording unit,
wherein the control unit controls the movement amount based on the relationship in a case where the tilt detection unit has detected that the recording unit is not in parallel with the first direction and controls the movement amount not based on the relationship in a case where the tilt detection unit has not detected that the recording unit is not in parallel with the first direction.

5. A recording method of forming dots onto a recording medium based on an interlace system, using a recording apparatus provided with a recording unit that includes a plurality of nozzles disposed at a regular nozzle interval in a first direction and has a plurality of recording heads which discharge a liquid from the nozzles and form the dots onto the recording medium and a carriage that moves the recording unit with respect to each of the first direction and a second direction orthogonal to the first direction,
wherein, in the recording unit, n (n is a natural number that is equal to or greater than 2) recording heads as the plurality of recording heads are disposed in the second direction, m (m is a natural number that is equal to or greater than 1) sets of the n recording heads are disposed in the first direction, and the n recording heads are disposed such that positions thereof in the first direction are shifted away from each other in a manner that an area occupied by the nozzles disposed within any one of the recording heads in the first direction and an area occupied by the nozzles disposed within the other one of the recording heads in the first direction overlap each other by a predetermined overlap amount, and
wherein the method comprises setting a movement amount when the recording unit is moved in the first direction, between one relative movement of the recording unit to the recording medium in the second direction and the next relative movement, to a regular amount Δy=HL (HL is the length of the recording head in the first direction)−OL (OL is the width of the overlap amount in the first direction)±PL (PL is the width of one pixel of printing resolution of a print image to be recorded by the recording unit in the first direction).
